(19) United States
(12) Patent Application Publication
(10) Pub. No.: US 2011/0077080 A1
(43) Pub. Date: Mar. 31, 2011

(54) 3D Gaming client for interactive musical video games inventor(s)

(76) Inventor: Syed Ashraf Meer, Brooklyn, NY (US)

(21) Appl. No.: 12/586,930

(22) Filed: Sep. 30, 2009

(51) Int. Cl. A63F 13/00; A63F 9/24

(52) U.S. Cl. 463/32; 463/35; 463/42

(57) ABSTRACT

A 3D gaming client in a mobile phone supporting interactive musical video games. Based on beats in an audio input, visual artifacts are created/and presented to the user in a 3D gaming environment. More than one virtual toy character may optionally be employed by the user to navigate and plan a musical video game as the audio input is played. As the user listens to beats of the musical source, the user's selected character(s) in the 3D gaming space encounters corresponding visual artifacts in the 3D visual space. Thus, the user visually experiences the beats/musical frequencies as dynamically created visual artifacts in a 3D environment, and plays a game by navigating to various points in the displayed 3D environment and by navigating over/around the visual artifacts for the musical frequencies encountered.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

1. Field of the Invention

The present invention relates generally to video game software, and more particularly a gaining client for playing interactive musical games.

2. Description of the Related Art

Musical video games are very popular with the youth. Such games can be played on video gaming consoles such as XBOX, Wii and PS3. They can also be played on some computers, such as laptops. Game consoles, computers and mobile devices are all considered “gaming platforms”. For example, a video game called Guitar Hero can be played on several of the competing platforms. Guitar Hero is a series of music video games first published in 2005 by RedOctane in which players use a guitar-shaped toy or peripheral to simulate the playing of lead, bass guitar and rhythm guitar across numerous rock music songs. Typically, players playing with the toy guitar match notes that scroll in 2 dimensions with a simple perspective distortion to appear “3D” on a screen (to which the XBOX 360 console is interfaced) to colored fret buttons on a controller for the console (the controller being the toy guitar component), pressing the controller buttons in time to the music in order to score points. Feedback on the screen is the provided to both indicate scoring and to create interactivity. WikiPedia reports that the Guitar Hero games attempt to mimic many features of playing a real guitar, including the use of fast-fingering hammer-ons and pull-offs and the use of the whammy bar to alter the pitch of notes. Most games support single player modes, typically a Career mode to play through all the songs in the game, and both competitive and cooperative multiplayer modes. The Guitar Hero video game series initially used mostly cover version of songs created by WaveGroup Sound, but most recent titles feature soundtracks that are fully master recordings, and in some cases, special re-recordings, of the songs. Later titles in the series feature support for downloadable content in the form of new songs.

Although popular, there are several drawbacks with the Guitar Hero video game. For example, the video displayed on a screen interfaced to the gaming console is a 3D image, with beat indicators that scroll on a screen. Although it is a 3d dimensional image, the player only interacts with one dimension as their avatar is merely moving horizontally.

A rudimentary version of a music oriented game, albeit for analog music, is described in U.S. Pat. No. 5,990,405, filed on Jul. 8, 1998, and issued on Nov. 23, 1999. It describes a technique wherein a musician can simulate participation in a concert by playing a musical instrument and wearing a head-mounted display that includes stereo speakers. Audio and video portions of a musical concert are pre-recorded, along with a separate sound track corresponding to the musical instrument played. However, this patent only covers musical instrument generating an instrument audio signal. It also covers only analog audio signals. It does not cover MIDI signals or other types of control signals.

U.S. Pat. No. 6,429,863 titled “Method and apparatus for displaying musical data in a three dimensional environment” does not in fact cover displaying musical data as a 3d environment—it merely covers placement of musical data within a 3d environment. The musical data does not influence or shape the 3d environment—rather it is positioned within a 3D environment,

The existing video gaming technologies in the industry supports delivery of some 2D animation for display while a user plays some music, or simulates playing of music. In particular, a user using a toy guitar or toy drums, that is attached to a gaming console, can simulate playing of the musical instrument, and attempt to follow musical notes displayed on a TV screen as a 2D image with some animation of the notes.

Further limitations and disadvantages of conventional and traditional approaches will become apparent to one of ordinary skill in the art through comparison of such systems with various aspects of the present invention.

### BRIEF SUMMARY OF THE INVENTION

The present invention is directed to apparatus and methods of operation that are further described in the following Brief Description of the Drawings, the Detailed Description, and the claims. Other features and advantages of the present invention will become apparent from the following detailed description of the invention made with reference to the accompanying drawings.

### BRIEF DESCRIPTION OF THE DRAWINGS

For various aspects of the present invention to be easily understood and readily practiced, various aspects will now be described, for purposes of illustration and not limitation, in conjunction with the following figures:

FIG. 1 is a perspective block diagram illustrating a 3D gaming client for interactive musical video games wherein portions of a dynamically created 3D game environment of the game extend toward the user in relation to the level of a defined frequency of the music;

FIG. 2 is a perspective block diagram of a 3D gaming client in an electronic device supporting interactive 3D experience of musical content; and

FIG. 3 is a flow chart illustrating an exemplary method of operating a 3D video gaming client in a mobile electronic device to visually display a current musical content as an interactive musical video game.

### DETAILED DESCRIPTION

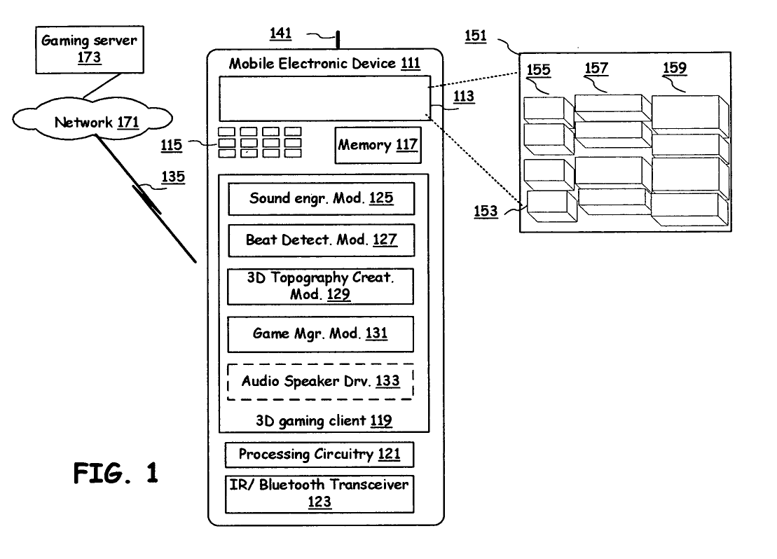

FIG. 1 is a perspective block diagram illustrating a 3D gaming client 119 for interactive musical video games wherein portions of a dynamically created 3D game environment of the game extend toward the user in relation to the level of a defined frequency of the music. The user is expected to either avoid or collide with specific areas of the 3D game environment by controlling an avatar (representing the user in the game) by pressing a key on an associated keyboard, by means of a mouse, by screen touch, etc.

The 3D gaming client 119 is installed on, and executed on, a mobile electronic device 111, such as a mobile phone. The 3D game environment created by the 3D gaming client 119 presents the user a virtual space to explore and play wherein visual artifacts are displayed that a user navigates around/over. In general, the visual artifacts that are displayed, and the very environment itself, are the products of data dynamically collected from an audio source. The audio source is a file stored locally that is played, a downloaded audio file, a streaming audio file, etc. The data collection from the audio source is dynamic and the 3D game environment created from the data collected is therefore also dynamic. The user thus navigates the avatar through such as dynamic virtual space to explore and play.

The user of the 3D gaming client 119 can associate one or more video game characters with himself/herself and travel through the 3D game environment encountering the visual artifacts. In the proximity of (or after encountering) a visual artifact in the 3D game environment, the user can take one of several possible actions, such as try to avoid a collision, pick up a game object, etc. The 3D game environment is generally provided as a 3D topography that is defined by parameters that respond to data collected from an audio input. This environment can be explored by a user using the avatar (sometimes referred to as a virtual toy character).

Musical beats in a current song being played determine the appearance of visual artifacts in the 3D game environment. Thus, at a certain point during the display of the visual artifacts on a screen on a mobile electronic device (with the 3D gaming client 119), the user presses a key on a keyboard 115 to play a game. In response to user input, the avatar moves in the 3D game environment. The resultant motion can be to avoid a visual artifact, to interact with a visual artifact, to pick up objects presented in the 3D game environment, etc.

The user is expected to play a musical video game in accordance with the musical beats that is visually presented to the user as geometrical shapes (such as trapezoids) in a 3D terrain or as geographical elements in a 3D outdoor scenery, etc. The geometrical shapes are animated in a pre-specified path (such as a vertical column) or along dynamically computed path. More specifically, in the proximity of a visual artifact in the topography, a “current region” of the 3D game environment is defined, wherein the current region is a virtual location in the 3D environment along a path on which the user explores/traverses employing a virtual toy character. The user is expected to play around the visual artifacts that are representative of beats in the current region. Any user input that is received is evaluated to determine if the user has interacted with the visual artifacts at the right time, or if the user has picked up/dropped items of interests that may have been presented as part of the game, such items of interest often dynamically placed in the 3D game environment by the 3D gaming client 119. User input is provided via the keyboard 115 of the mobile electronic device 111, although other means of gathering user input are also contemplated, such as optical mouse, etc.

The 3D gaming client 119 is typically installed on and played on the mobile electronic device 111, such as a mobile phone, and the user plays a game in accordance with the displayed musical frequencies/beats. The user is awarded points based on the user's ability to play around the 3D gaming environment while the visual artifacts are dynamically created and presented in the musical video game.

In general, visual artifacts based on beats detected from a current song/musical content are displayed in a visual 3D environment by the 3D gaming client 119 wherein the user navigates in the displayed 3D environment using an avatar/a virtual toy character that represents the user in the virtual 3D gaming environment (selected from an available set of characters) to certain points of the 3D game space. As the user navigates/travels, the virtual toy character (i.e. the user) encounters various visual artifacts in a 3D topographical terrain. The 3D gaming client 119 presents a visual 3D environment by processing (dynamically) a musical source such as a downloaded audio file or a streaming audio file. For example, based on beats in the musical source, visual artifacts are created/presented to the user. More than one virtual toy character may optionally be employed by the user in a musical video game. As the user listens to beats of the musical source, the user's selected character(s) in the 3D gaming space encounters corresponding visual artifacts in the 3D visual space. Thus, the user visually experiences the beats/musical frequencies as dynamically created visual artifacts in a 3D environment, and plays a game by navigating to various points in the displayed 3D environment and by navigating over/around the visual artifacts for the beats/musical frequencies encountered.

The 3D gaming client 119 in the mobile electronic device 111 typically comprises a sound engineering module 125, a beat detection module 127, a 3D topography creation module 129, a game manager module 131 and optional audio speaker drivers 133. The sound engineering module 125 facilitates recording and reproduction of sound through mechanical and electronic means. The 3D topography creation module facilitates creation of various types of 3D game environment, such as a topography comprising a ground surface with small hills over which a user's virtual toy character can travel while encountering visual artifacts based on beats/musical frequencies detected by the beat detection module 127. The 3D topography creation module can also display a region of space with planets over which the user's virtual toy character can travel visiting asteroids, planets, etc.

The game manager module 131 coordinates collection of actual user input in order to determine navigation by the user in the current 3D video game. It also coordinates display of a user requested 3D game environment per user's preferences and choices, and the display of appropriate beats/musical frequencies as visual artifacts in appropriate locations in the 3D video space based on the “current region” in the topography for the user. The game manager module 131 also causes the creation of audio and visual feedback to the user on the screen 113 of the mobile electronic device 111, when the user presses a key of a keyboard 115 or provides user input in one of several possible methods.

The 3D gaming client 119 of the present invention makes it possible to create and play a series of music video games in which players use keys on the mobile electronic device 115, an optical mouse or other input devices to play a game while experiencing the music as a dynamically created 3D environment presenting one of a plurality of 3D terrains. For example, the user plays/navigates around the geometrical shapes dynamically created based on beats/musical frequencies on the screen of the mobile electronic device 111 employing the keys of the keypad 115 provided. All the while, the user experiences a current song as a 3D trapezoidal terrain wherein 3D trapezoidal objects 153 representing beats move along paths 155, 157, 159 (such as vertical columns) in the dynamically determined 3D trapezoidal terrain presented to the user in the exemplary screen display 151.

The present invention provides new and innovative ways in which a user interacts with a song/music being played/listened to by the user, and turns the experience into a musical video game—it presents a new 3D way of experiencing music using dynamically created topography wherein the user can navigate through the associated music topography and also play a game.

The 3D gaming client 119 is capable of playing musical video games that the user downloads, stores locally, etc. It displays musical beats/musical frequencies in a visual 3D environment on the mobile electronic device (such as a mobile phone or another electronic device) and generates an entirely new gaming experience. In particular, the user, while playing a musical video game employing the 3D gaming client 119 on the mobile electronic device 111, can tilt, rotate, and zoom into a presented 3D space and change his viewing 3D perspective. In response to the 3D perspective changes that the user initiates, the 3D gaming client 119 in the mobile electronic device 111 modifies the visual 3D environment.

Typically, the 3D gaming environment presented to a user by the 3D gaming client 119 of the mobile electronic device 111 comprises a region of video space with a topography displayed, wherein the topography comprises visual artifacts, such as a range of small hills, over which a virtual toy character (or toy play character that can be selected by user), representing the user in the game, traverses. User input is solicited/anticipated as the user approaches some of the visual artifacts, such as small hills in a terrain of a 3D topography comprising an undulating hilly visual space. In general, the various visual artifacts provide the user with a visual experience of corresponding beats/musical frequencies of a music being played. The resultant user input, such as pressing of keys 115 is collected. In response the 3D gaming client 119 processes the user input and plays one or more feedback jingles/notes to provide a user an audio feedback.

The 3D gaming client 119 manages the topography and provides local detail for the topography in general, including not only relief but also vegetative and human-made visual artifacts, based on beats detected in a current musical source. For example, the size and shape of visual artifacts can be determined by frequency and or amplitude of beats encountered during a dynamic analysis by the beat detection module 127. Visual artifacts selected to represent beats in a 3D terrain may include elements depicting local history and culture. Such topography also specifically involves the recording of relief or terrain, the three-dimensional quality of the surface, and the identification of specific landforms, both natural and man-made.

Each of the visual artifacts in the topography display one or more beats/musical frequencies as the user's virtual play character approaches (for example). Thus, actual user input prompted by the specific topographical features represented by visual artifacts, such as the small hills, is collected and game awards computed if necessary. Feedback, visual as well as in audio form, is presented to the user to indicate how successful the user has been in responding to the visual and audio hints/cues presented to the user at the visual artifacts.

In one embodiment, the 3D gaming environment presented to a user by the 3D gaming client 119 of the mobile electronic device 111 comprises a visual image of a topographical ground, with perspective changing options, wherein musical beats/musical frequencies are dynamically represented as a plurality of topographical features (visual artifacts), such as small hills/bumps in the topography. Each of the plurality of small hills may be of different heights, diff widths, etc. The visual image of the topographical terrain and surface features may display a texture, one or more guiding paths or lines, and it presents a continuous surface. When the user starts a musical video game, beats/musical frequencies are processed and a corresponding 3D environment is presented employing one of a plurality of terrains (selected by user or provided by default). The user plays the musical video game by travelling through/around the various visual artifacts. For example, the user travels through the various small hills displayed in the topographical terrain, in a specific order, interacts with game objects presented. Thus, the user can travel in the 3D topographical terrain of the gaming environment. In one related embodiment, by merely driving a car or a vehicle over the small hills presented as part of a terrain, the user can participate in the 3D musical game. In a different embodiment, the user has to not only drive a vehicle over the small hills presented in a topographic terrain, but also activate a right key from a set of recommended keys, in order to pick up game objects, drop them at specified places, etc.

In general, the 3D gaming client 119 facilitates tilting the view, displaying a top view of the topographical terrain (solid ground, or a large body of water, for example) in the 3D gaming environment, etc. The user, employing one or more play characters representing the user in a video game, navigates through the topographical terrain and experiences the beats/musical frequencies presented as a dynamically created 3D environment. In related embodiments, the user is required to avoid crashing into obstacles presented in the topographical terrain as the user navigates through the topographical terrain and experiences beats/musical frequencies. When a crash occurs, an audible sound is presented along with a visual indication to show that the crash has occurred. In a different but related embodiment, the user can continue to play the game (and play musical frequencies) despite a crash at one of the visual artifacts.

The 3D gaming client 119 facilitates gathering of game points by a user. For example, if the user successfully avoids crashing into obstacles presented in the topographical terrain as the user navigates through the topographical terrain and experiences musical frequencies, the user is granted game points. Bonus points are also awarded if the user completes a whole course in the terrain without any accidents or crashes, and is able to correctly navigate on paths provided. In addition, while traversing through the topographical terrain and experiencing 3D representation of beats/musical frequencies, the user can also pick up gift items that provide additional capabilities to the visual play character being used by the user and/or provide bonus points. Awarding and tracking game points earned by a user if facilitated by the game manager module 131.

The topographical terrain presented and managed by the 3D topography creation module 129 is usually depicted as a continuous surface, although this need not be the case. Thus, surfaces need not be continuous, although it is in some versions. The beats/musical frequencies from a video game played by the user on the mobile electronic device 111 is used to create and present a topography of 3D representation wherein the virtual toy character representing the user traverses and experiences music. The generation of the topography of 3D representation occurs in real time, as the musical frequencies for a song/musical source are converted into a selected 3D video environment. Thus, the topography is data driven, and traversing through the topography results in animation. Such animation is implemented by procedural code/instructions, but need not be limited to it.

In one embodiment, the 3D gaming client is integrated into the mobile electronic device 111. The mobile electronic device 111 comprises a screen 113, a keypad 115, an infrared (IR)/Bluetooth transceiver 123, a sound engineering module 125, a beat detection module 127, a 3D topography creation module 129, a game manager module 131 and audio speaker drivers 133. The beat detection module 127 detects rhythmic beats of the current music source/song and is able to determine beat frequency, amplitude, etc. It then converts them to a predefined format. The beats are detected in response to preset parameters defined for a video game, or as specified by the user. For example the user provides user input by entering it via the keypad 115. The predefined format pertains to a global standard.

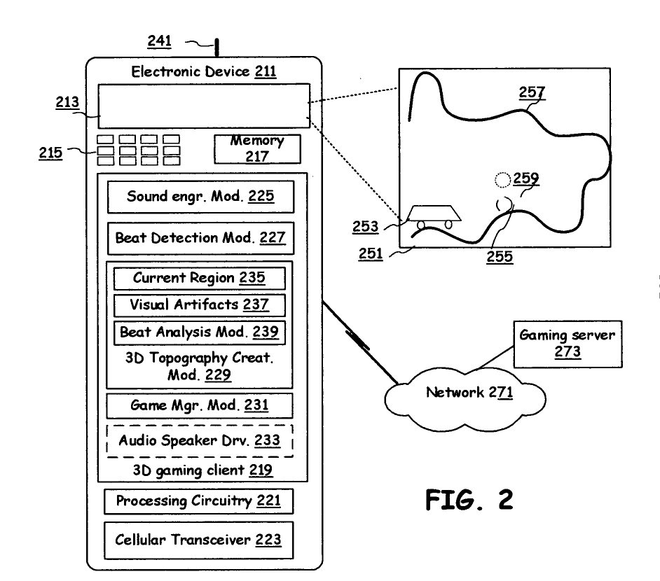

FIG. 2 is a perspective block diagram of a 3D gaming client 219 in an electronic device supporting interactive 3D experience of musical content. The user is able to play a video game while listening to music, wherein the 3D gaming client 219 dynamically creates a 3D gaming environment based on beats detected in a current musical content. The electronic device 211 is similar to the mobile electronic device 111 of FIG. 1. It is capable of downloading songs/musical content and providing a 3D musical experience, the songs/musical content being available for download from a remote gaming server 273 via a network 271. The 3D gaming client 219 comprises a 3D topography creation module 229 that is capable of displaying a 3D topographic terrain with a plurality of visual artifacts along a path through the 3D terrain, with visual artifacts being based on beats detected in musical content.

The 3D gaming client 219 comprises a 3D topography creation module 229, which in turn comprises a visual artifacts generator 237, a beat analysis module 239 and a current region manager module 235. The visual artifacts generator 237 creates and manages one or more visual artifacts within the 3D topographic terrain, along one or more paths. Paths are columns or other structures that guide user navigation. The visual artifacts generator 237 changes the shape, size, color and other characteristics of visual artifacts based at least partly on beats detected by the beats detection module 227, selected viewing perspectives and the current state of the musical video game. The beat analysis module 239 adapts the size, shape, style and positioning of the visual artifacts in the current musical content by determining the frequency, amplitude and other characteristics of beats detected.

The current region manager module 235 manages the motion of the virtual toy character within the 3D topographic terrain. It is capable of motion along random paths or along predetermined paths in the 3D topographic terrain.

The 3D gaming client 219 executes on a processing circuitry 21 of the electronic device 211. An exemplary 3D topography generated by the 3D gaming client 219 is shown by the screen 251, wherein the 3D topography terrain comprises multiple hills 255, 257, each hill serves as a visual artifact, in the 3D topography terrain. The visual artifacts, such as hill 255, are displayed based on analysis of corresponding beats detected/associated in the musical content being played, such musical content being either played from a local storage or remotely streamed from the gaming server 273.

In one embodiment, the 3D gaming client 219 generates the 3D topography terrain of screen 251 for a current musical content, converting the experience to an interactive musical video game, the beats in the music being displayed as appropriate ones of the plurality of visual artifacts 255, 257 as necessary. The display of the game object 259 can take different shapes or forms based on the type of musical video game being played and based on user preferences. The user is expected to pick up the game object 259 while navigating in proximity to the hill 255. The shape, relative location and other characteristics of the game object 259 can also be changed at runtime. Similarly, the selection of the toy virtual character representing the user is facilitated by the 3D gaming client 219, with default shapes and sizes provided for ease of use.

The 3D gaming client 219 accepts accept user input as the user travels along a path (suggested path or random ones selected by the user) in the generated 3D topography terrain using a virtual toy character 253 provided. It awards points to the user based on user's ability to pick up the object 259.

In one embodiment, the 3D topography terrain for a current musical content is generated based on user preferences. In a related embodiment, the 3D gaming client 219 presents a visual error indication and an audio error indication when the virtual toy character 253 is in proximity to one of the plurality visual artifacts 255 and the user fails to pickup the game object 259.

In one embodiment, the 3D topography terrain is a hilly region, the toy character 253 provided by the current one of the interactive musical video games is a car and the plurality of visual artifacts 255, 257 are hills over which the user travels employing the car while experiencing the current musical content as a 3D video game.

In one embodiment, the electronic device 211 that comprises a 3D gaming client 219 is a cellular phone. It comprises a screen 213, a keypad 215, a memory 217, a cellular transceiver 223, and an antenna 241. The cellular transceiver 223 operates in pursuance to a cellular communication standard, for example and without limitation, CDMA, GSM, EDGE, cdma2000, WCDMA, WiMAX or LTE. The cellular phone 211 is associated with a terrestrial cellular network 271 (via an access point) and communicates with the gaming server 273.

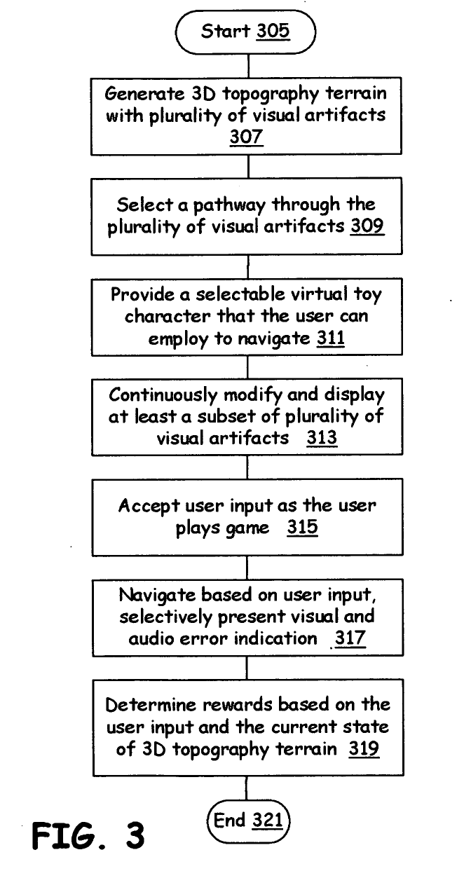

FIG. 3 is a flow chart illustrating an exemplary method of operating a 3D video gaming client in a mobile electronic device to visually display a current musical content as an interactive musical video game. The operation starts at a start block 305 when the user activates the 3D video gaming client in a mobile electronic device. Then, at a next block 307, the 3D video gaming client generates a 3D topography terrain with a plurality of visual artifacts. The 3D topography terrain comprises selectable texture wherein the plurality visual artifacts can be customized by the user. Then, at a next block 309, the 3D video gaming client facilitates user selection of a pathway through the plurality visual artifacts. At a next block 311, it provides a selectable virtual toy character that the user can employ to navigate through the 3D topography terrain. Then, at a next block 313, it continuously modifies and displays at least a subset of plurality of visual artifacts. It displays at least a subset of the beats associated with the current music and makes it into a musical video game. The 3D topography dynamically changes as the user navigates through the 3D topography terrain employing the virtual toy character to experience the current musical content being played.

At a next block 315, the 3D video gaming client accepts user input associated with one of the plurality visual artifacts when the virtual toy character is in proximity to it. In one embodiment, user input received is processed to determine if it is appropriate when the virtual toy character is in proximity to the associated visual artifact. Then, at a next block 317, the 3D gaming client plays selectively presented visual and audio error indication based on user input. It also presents a visual error indication and an audio error indication when the user fails to complete the anticipated action/navigation when the virtual toy character is in proximity to the associated visual artifact.

Then, at a next block 319, the 3D gaming client determines rewards based on user input and anticipated user behavior. It then awards game points based on the appropriateness of user input/action for the current state of the 3D topography terrain. The process finally terminates at an end block 321.

In one embodiment, the 3D video gaming client supports gathering a gift item as the user navigates close to at least one of the plurality visual artifacts that comprise the gift item. It then enhances the capability of the virtual toy character based on the gift item.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “operable to” indicates that an item includes one or more of power connections, input(s), output(s), etc., to perform one or more its corresponding functions and may further include inferred coupling to one or more other items. As may still further be used herein, the term “associated with,” includes direct and/or indirect coupling of separate items and/or one item being embedded within another item. As may be used herein, the term “compares favorably,” indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A 3D gaming client for playing a musical video game on an electronic device, the 3D gaming client comprising:
a sound engineering module;
a beat detection module;
a 3D topography creation module;
a game manager module;
the sound engineering module facilitating reproduction of sound through electronic means and being further operable to generate musical signals based on audio input from an audio source;
the beat detection module operable to detect beats from the audio input;
the 3D topography creation module facilitating dynamic creation of one of a plurality of 3D topographical terrains based on detected beats, each of the plurality of topographical terrains comprising dynamically created visual artifacts based on corresponding beats from the audio input;
the game manager module facilitating navigation by the user in a path over the one of the plurality of terrains employing a virtual toy character; and
the game manager module providing a dynamically generated 3D musical gaming experience by managing the generation of music by the sound engineering module, the dynamic display of the one a plurality of 3D topographical terrains based on the audio input by the 3D topography creation module and the navigation of the virtual toy character in the one a plurality of 3D topographical terrains.

2. The 3D gaming client of claim 1 wherein the game manager module coordinates collection of the user input and, in response, controls navigation of the virtual toy character in the one a plurality of 3D topographical terrains.

3. The 3D gaming client of claim 1 wherein the audio input is in one of a set of industry standard formats comprising WAV, MP3, VOX, RAW, WMA, RA and RAM.

4. The 3D gaming client of claim 1 wherein the electronic device is a cellular phone.

5. The 3D gaming client of claim 4 wherein the game manager module displays audio and visual feedback, in response to user input provided by the user employing at least one key of a keyboard associated with the cellular phone.

6. The 3D gaming client of claim 5 wherein the 3D gaming client displays one of a plurality of 3D topographical terrains based on beats detected in the audio input, wherein the audio input is locally retrieved from a local storage in the cellular phone.

7. The 3D gaming client of claim 6 wherein the game manager module facilitates the replacement of the one of a plurality of 3D topographical terrains with another of the plurality of 3D topographical terrains.

8. A 3D gaming client in a mobile phone that supports user interaction, the 3D gaming client comprising:
a beat detection module that is operable to detect beats in an audio input;
the 3D gaming client providing a dynamically created 3D visual gaming environment wherein the visual artifacts dynamically presented are based on beats detected in the audio input by the beat detection module; and
the 3D gaming client facilitating navigation employing an avatar in the dynamically created 3D visual gaming environment.

9. The 3D gaming client of claim 8 capable of processing user input provided via a keyboard associated with the mobile phone and, in response to the user input, managing navigation of the avatar in the 3D visual gaming environment.

10. The 3D gaming client of claim 8 wherein the visual artifacts dynamically presented comprise of geographical shapes that are animated along paths.

11. The 3D gaming client of claim 8 wherein the beats detected are represented as dynamically created visual artifacts in the 3D visual gaming environment, wherein the 3D gaming client facilitates navigation to various points in the displayed 3D visual gaming environment based on user input.

12. The 3D gaming client of claim 8 wherein 3D gaming client awards points based on navigation in the 3D visual gaming environment and interactions with at least one of a plurality of gaming objects displayed in 3D visual gaming environment.

13. The 3D gaming client of claim 8 wherein the 3D visual gaming environment comprises a 3D topography terrain of a hilly region, the avatar provided is a car and wherein the plurality of visual artifacts are hills in the hilly region over which the user travels employing the car.

14. A method of operating a 3D video gaming client in a mobile electronic device to provide an interactive 3D musical experience, the method comprising:
generating a 3D topography terrain with a plurality visual artifacts;
facilitating selection of a pathway through the plurality of visual artifacts;
offering a selectable virtual toy character that the user can employ to navigate through the 3D topography terrain;
accepting user input as the user navigates in the generated 3D topography terrain comprising the plurality of visual artifacts; and
providing an interactive 3D musical experience.

15. The method of claim 14, wherein the 3D topography terrain comprises a selectable texture and wherein the plurality of visual artifacts can be customized by the user.

16. The method of claim 14, further comprising:
processing user input received when the virtual toy character is in proximity to the at least one of the plurality visual artifacts; and
determining correctness of user input and awarding points.

17. The method of claim 16, further comprising:
awarding game points based on users actions wherein the user actions comprises navigating the avatar to avoid obstacles and picking up game objects selectively.

18. The method of claim 14 further comprising:
gathering a gift item as the user navigates close to at least one of the plurality visual artifacts that comprise the gift item; and
enhancing, selectively, the capability of the virtual toy character based on the gift item.

19. The method of claim 14 further comprising:
placing a gift item in the 3D topography terrain; and
facilitating the gathering of the gift item by the user employing the virtual toy character; and
enhancing the capability of the virtual toy character based on the gift item.

20. The method of claim 14 further comprising:
presenting a visual error indication and an audio error indication when the user fails to play in accordance with a game rule while navigating in the 3D topography terrain comprising the at least one of the plurality visual artifacts.
